(19) United States
(12) Patent Application Publication
(10) Pub. No.: US 2020/0203111 A1
(43) Pub. Date: Jun. 25, 2020

(54) Electrically Triggerable Fusible Link Opening Element of an Extinguishing Fluid-Conducting Element

(71) Applicant: Minimax Viking Research & Development GmbH, Bad Oldesloe (DE)

(72) Inventor: Joachim Böke, Bad Oldesloe (DE)

(21) Appl. No.: 16/703,441

(22) Filed: Dec. 4, 2019

(30) Foreign Application Priority Data
Dec. 19, 2018 (DE) 102018132859.1

(51) Int. Cl. H01H 85/22; H01H 89/00; A62C 37/36; A62C 37/14; A62C 37/40; A62C 37/50

(52) U.S. Cl. CPC H01H 85/22; H01H 89/00; A62C 37/50; A62C 37/14; A62C 37/40; A62C 37/04

(57) ABSTRACT

There are a large number of different sprinklers which are used in firefighting installations, in particular a water extinguishing installation having a blocking and an enabled state, wherein the extinguishing fluid-conducting element has a fusible link opening element having a predetermined electrical resistance, wherein the fusible link opening element is integrated in an electrical circuit which has a switch (S) and through which when the switch (S) is closed there flows a current by which the fusible link opening element is opened.

### PRIORITY CLAIM

This application claims priority to German Patent Application No. 102018132859.1 filed Dec. 19, 2018, the contents of which is incorporated herein by reference in its entirety.

### DESCRIPTION

There are a large number of different sprinklers which are used in firefighting installations.

In that respect there are known inter alia fusible link sprinklers or however also sprinklers with a “thermally triggering glass bulb”, also referred to as “Thermo Bulbs”. Such Thermo Bulbs are standard in the sprinkler industry.

With the Thermo Bulb principle a closed glass bulb is filled with at least one medium, for example gas, or at least two media (liquid and gas bubble). Upon heating the gas and/or the liquid expands and in that situation a pressure is built up in the interior of the glass bulb until a threshold value pressure is reached at which the glass bulb bursts/ruptures and thus enables the sprinkler function and the fluid extinguishing agent flow. The glass bulb itself is in that case also mechanically prestressed, that is to say it presses against a closure which is acted upon on the opposite side with the water pressure in the piping.

The situation is different in the case of fusible link sprinklers in which the fusible link is under a mechanical prestressing so that, when the temperature in the environment around the fusible link rises, for example because of a fire occurring or another thermal event, the fusible link softens at a defined temperature, melts or the like and thus by virtue of the mechanical prestressing the fusible link yields and enables the sprinkler function and the fluid extinguishing agent flow.

Under certain conditions it may be desirable if the sprinkler function, that is to say fighting a fire with the sprinkler, is already enabled before an actual fire event assumes major proportions and before the thermal energy of the fire event in any way causes triggering of the known sprinklers. In addition in the event of a fire spreading rapidly it may be appropriate to also trigger sprinklers around the actual fire, in order for example to implement pre-wetting.

In this connection attention is directed as state of the art to WO2017/105289.

That state of the art discloses a sprinkler with a glass bulb (Thermo Bulb principle) and applied to the outside of the bulb is an electrically conductive coating forming an electrical resistance (R) which if necessary can have a current caused to flow therethrough by closing a switch and applying a voltage.

Consequently the glass bulb and thus the medium in the glass bulb are heated until a thermal limit is reached, at which the glass bulb bursts in order thereby to enable the sprinkler function.

The above-mentioned structure however is highly complicated and in particular production of the glass bulb and the electrically conductive coating which at the same time forms an electrical resistance is very complicated and laborious and gives rise to additional costs.

Finally it also suffers the disadvantage that, when the sprinkler is mounted beneath a ceiling or on a wall over years or even decades as part of a firefighting installation it is possible for dust, spider webs or other influences to be deposited on the glass bulb and, in the situation where then electrical triggering of the sprinkler is required, a part of the applied current does not flow by way of the layer on the outside of the glass bulb but somewhere else, for example by way of spider webs or “short-circuits” formed from dust or deposited material.

In that case it is under some circumstances too long before the medium in the glass bulb is heated and thus the glass bulb is “burst open”.

The object of the present invention is to provide a solution for a fusible link opening element of extinguishing fluid-conducting elements for a firefighting installation, which permits a higher degree of reliability and functional security than the known solutions.

In accordance with the meaning of the present application an extinguishing fluid-conducting element is in that respect for example a fusible link sprinkler or a control valve with fusible link opening element or another device, in respect of which the flow of the extinguishing fluid is made possible by means of a fusible link opening element only after triggering of the fusible link opening element.

According to the invention that object is attained with an extinguishing fluid-conducting element having the features as set forth in claim 1.

Advantageous developments are recited in the appendant claims.

In addition the present application and invention also concerns a firefighting installation having an extinguishing fluid-conducting element, and also a method of testing an extinguishing fluid-conducting element.

The invention is based on the realization that the fusible link opening element regularly comprises electrically conductive parts and that by incorporating the fusible link opening element into an electrical circuit it is possible that the current will not only flow through the conducting parts of the fusible link opening element, but that in that situation the fusible link is heated to a predetermined temperature so that in that way the fusible link opening element is opened and thus the extinguishing fluid-conducting element is triggered.

In a variant of the extinguishing-fluid conducting element it is possible that an electrically operable thermoelement, for example a heating resistance, is arranged in contact with the fusible link or in the immediate vicinity thereof.

If then a current flows through the electrically heatable element by virtue of closing a switch it heats up very greatly and causes fusing of the fusible link, as a consequence of which that leads to triggering of the extinguishing fluid-conducting element. In regard to that heating the heating resistance can also be of such a configuration that it is virtually triggered itself, like for example a classic fuse.

Triggering of the switch does not necessarily only presuppose a fire, but can also occur when another parameter in the room on the surface where the extinguishing fluid-conducting element is arranged exceeds a predetermined value. If for example the room is provided with a smoke detector the switch can be caused to close when a predetermined smoke value is exceeded. In the situation where a radiation sensor is installed closing of the switch is triggered when a given radiation value is exceeded. If a given heat sensor is installed in the room closure of the switch is triggered when a given room temperature is exceeded. In one of the above-mentioned cases therefore a suitable sensor, for example smoke, radiation, heat, temperature sensor etc performs a control function and causes closure of the switch when a predetermined value which is ascertained by the respective sensors is exceeded.

Preferably in that case the heating element is electrically insulated outwardly so that, in the situation where spider webs, dust, textiles or other weave materials should have become deposited on the heating element, they cannot adversely effect the flow of electric current.

In that way also after many years or decades when the sprinkler function has not been triggered, spider webs, dusts, textiles fibers and so forth which are regularly in the air and which also settle on the fusible link, cannot adversely affect the electrical heating function of the thermoelement.

The invention is described with reference to the embodiments by way of example hereinafter and illustrated in drawings.

In regard to the basic function the following is to be mentioned here:

The electrically heatable heating element, for example the heating resistance R, is connected to a voltage source and an opened switch S, by means of closure of the switch S current I flows out of the voltage source through the resistance R and then generates there thermal energy in accordance with the formula “I²R”.

Closure of the switch S can already occur when a fire event has occurred but the temperature at the sprinkler is not yet sufficiently high enough to cause triggering of the sprinklers.

In that case the voltage source can be a battery but can also be the normal electrical power supply system and it is possible for a switch, disposed for example in the fire alarm and/or extinguishing control center, to cause triggering of a large number or a defined number of sprinklers.

Thus for example it is also conceivable that, when a plurality of sprinklers are provided in a building, they are arranged in given groups and can also be operated group-wise by way of switch triggering (controlled from the fire alarm center) of the individual sprinklers, which is important in particular for fighting fires which spread quickly.

It is however also possible for all sprinklers to be triggered simultaneously with a single switching command.

The invention is described hereinafter by means of examples and also with reference to drawings in which:

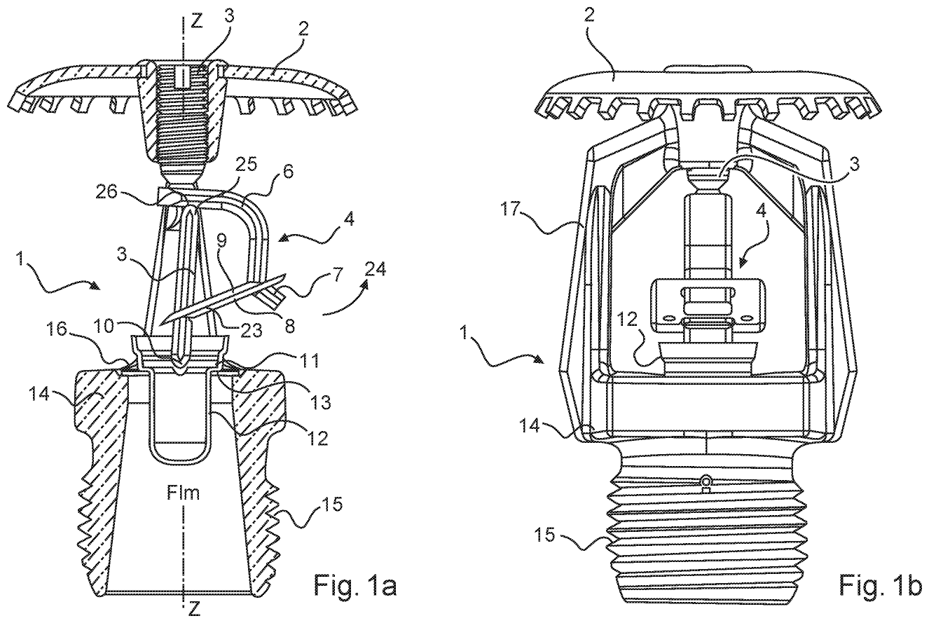

FIG. 1a shows a cross-section through a known extinguishing fluid-conducting element of a firefighting installation,

FIG. 1b shows a side view of an extinguishing fluid-conducting element as shown in FIG. 1a,

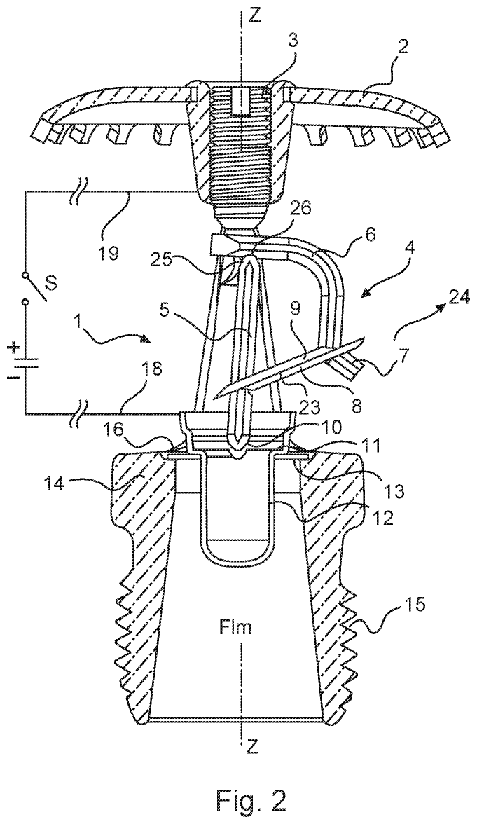

FIG. 2 shows a cross-sectional view through an extinguishing fluid-conducting element according to the invention in the form of a fusible link sprinkler,

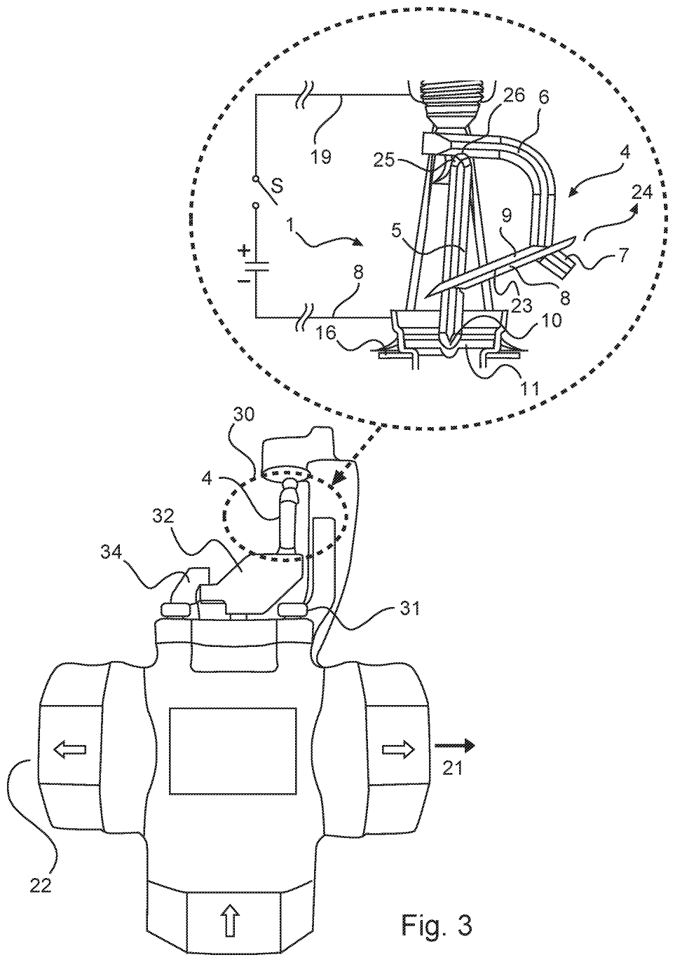

FIG. 3 shows a diagrammatic view of an extinguishing fluid-conducting element in the form of a control valve with fusible link opening element,

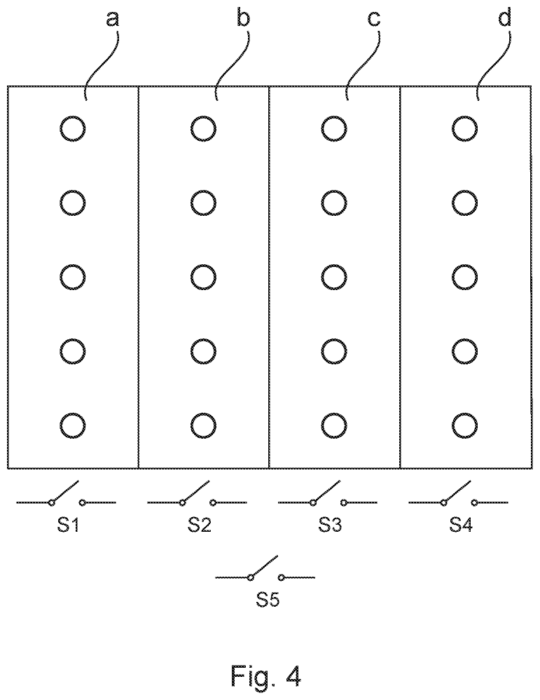

FIG. 4 shows a diagrammatic view of a zonal division of a room in which different regions can be supplied with extinguishing fluid,

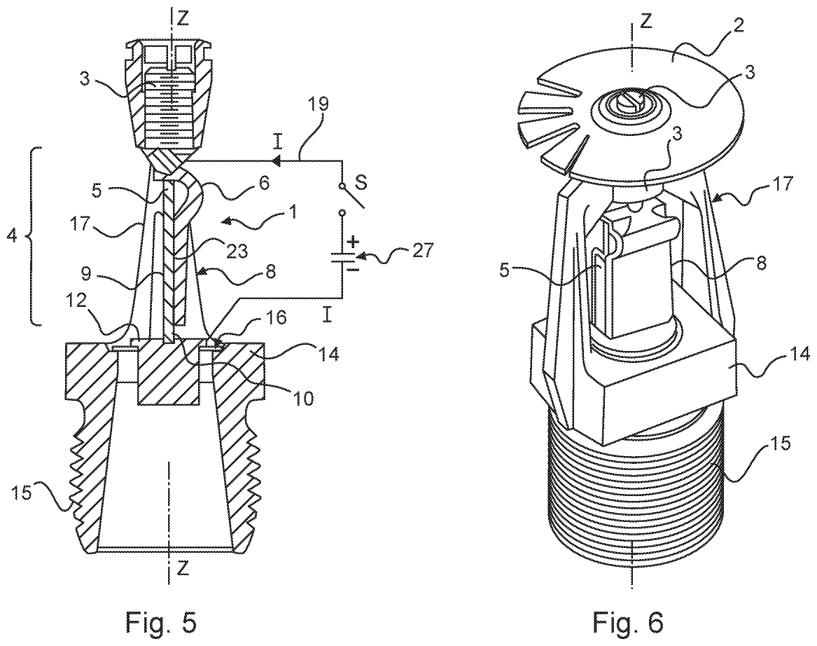

FIG. 5 shows a cross-sectional view of an alternative configuration as shown in FIG. 1a, and

FIG. 6 shows a perspective view of an extinguishing fluid-conducting element as shown in FIG. 5.

FIG. 1 shows in the two views in FIG. 1a and FIG. 1b the cross-section (FIG. 1a) and the view (FIG. 1b) of a known fusible link sprinkler with a fusible link triggering element.

Such a sprinkler 1 has a detector 2 which has a screw 3 passing centrally therethrough. The triggering mechanism 4 of the fusible link triggering element can be adjusted with that screw, the triggering element for example comprising a rod 5, a curved lever 6 mounted between the screw 3 and the rod 5, and two plates connected by a fusible link.

As can be seen from FIG. 1a the lever 6 with its front part 7 carries a plate 8. Resting on that plate 8 is a further plate 9 which in turn is carried by a straight lever 5. The fusible link 23 is located therebetween and initially connects the two plates.

The straight lever 5 has a foot end 10 which rests on a support 11 which in turn is received by a receiving means 12 (a so-called pip cap). In addition each lever has a head end 25 which is disposed in a recess 26 in the lever 6. That receiving means 12 has a peripherally extending shoulder 13 bearing on a spring 16, for example a plate spring (Belville), which is in the form of a circular ring, and comes to bear at the outside on the frame of the sprinkler body 14. In the lower region the sprinkler body 14 has a thread 15 which can be screwed into a pipe, through which water or another fluid extinguishing agent is supplied to the sprinkler and, as the sprinkler body 14 is internally hollow, pushes the fluid extinguishing agent (indicated by Flm) against the receiving means 12 and the spring 16 from the interior.

The spring 16 is coated with Teflon to deploy a sealing action which is as great as possible, for as long as the sprinkler triggering mechanism 4 is still in the sprinkler 1, a sufficient force must be opposed to the pressure of the fluid extinguishing agent (Flm) and at the same time the fluid extinguishing agent may also not escape from the interior of the sprinkler body 14.

FIG. 1b shows the side view of the sprinkler shown in FIG. 1a.

It can be clearly seen therefrom that the sprinkler body 14 has an O-shaped frame 16 carrying the deflector 2. The frame 17 in this case is a part of the sprinkler body 14 and, as can be seen, the screw 3 passes through the frame 16 where the deflector is also held by the frame.

If now the screw 3, as shown in FIGS. 1a and 1b, is tightened (that is to say moved downwardly in the view), then it presses (stresses) the triggering mechanism 4 by way of the foot region 10 of the rod 5 into the support. At the same time in that case the receiving means 12 is pressed against the inner region of the spring 16 and thereby also applies the spring 16 with its outer region in sealing relationship against the sprinkler body 14.

As can also be seen from FIG. 1a the connection between the rod 5 and the lever 6 is arranged slightly displaced out of the central axis Z. Accordingly by tightening the screw 3 a force is also applied to the lever 6, the outer region of which seeks to move away from the rod 5.

It will be appreciated however that this is prevented by the two plates 8 and 9 being connected with a fusible link 23.

The fusible link can be of such a nature depending on the respective use, location, type and wish, that it melts at a desired temperature, and, when that is the case, the plates 8 and 9 are released from each other, that is to say the front part 7 of the lever 6 moves outwardly (towards the right in the direction 24 in FIG. 1a) and the entire triggering mechanism drops out of its arresting engagement as shown in FIG. 1 with the consequence that there is now no longer any pressure acting from the outside in opposition to the internal pressure of the fluid extinguishing agent and the latter thus flows out of the interior of the sprinkler body 14 and in so doing preferably sprays against the deflector 2 which provides that this causes a desired sprinkler disk or fan spread.

FIG. 2 shows a development according to the invention of the known sprinkler.

In that respect the following preliminary remarks are in order.

In the ideal case, upon melting of the fusible link, all parts of the triggering mechanism are detached from the sprinkler in order not to interfere with or divert the fluid flow of the extinguishing agent.

The sprinkler body 14 regularly comprises metal, for example brass, the deflector also comprises metal, for example phosphor bronze, the support 11 also comprises metal, for example brass, the screw 3 also comprises metal, for example stainless steel and the levers 5 and 6 also comprise metal, for example stainless steel. The two fusible link plates 8 and 9 also comprise metal, for example a nickel-beryllium alloy, and the receiving means 12 also comprises metal, for example brass or copper.

The spring 16 also comprises metal but is also coated for example with polytetrafluorethylene (Teflon). This means that the receiving means 12 resting on the spring 16 is electrically non-conductingly connected to the sprinkler body 4.

It is now also possible to see from FIG. 2 that the frame of the sprinkler body 14 but at least the screw 13 is connected by way of an electric line to the pole of a voltage source. By way of a further line there is a connection in the foot region 10 of the lever 5 to the other pole of the voltage source 27. It can be seen from the view that the electric line between the foot region of the lever 5 and the voltage source 27 is made by way of the electrically conducting support 11 which is electrically conductingly connected to the receiving means 12, to which the first electric line 18 is clamped. The second electric line 19 can be releasably or non-releasably mounted/connected (for example screwed, soldered, and so forth) to the frame of the sprinkler 14 but also directly to the screw 3 or the head end 25 of the triggering mechanism 4 or another part of the sprinkler body.

It can also be seen that there is a switch S which is in the “open position” in FIG. 2. By closure of the switch S current can finally flow through the frame of the sprinkler body, the parts of the triggering mechanism which are metallically connected thereto, with the support 10 and the receiving means 12, which, as mentioned, comprise electrically conducting materials.

Accordingly a current then flows through the frame of the sprinkler 14, through the screw, the levers 5 and 6 and through the plates 7 and 8.

In the situation where the second electric line 19 is fitted to the frame 14 or the screw 13 or the lever 6 and between the head end 25 of the rod 5 on the one hand and the recess 26 in the lever 6 on the other hand there is an electrical insulation by providing there for example an electrically non-conducting material or seal, for example plastic, the electric current then flows solely through the lever 6 and the plates 8 and 9 as well as the fusible link 23 to the foot region 10 of the rod 5, so that in that way the maximum current can flow through the plates 8, 9 and the fusible link 23, in order thereby to raise the temperature of the fusible link to the fusing temperature as quickly as possible.

As, as mentioned, the spring 16 is coated with Teflon that spring 16 electrically insulates the receiving means 12 from the frame of the sprinkler 14.

The flow of current has the consequence that instantly the levers 5 and/or 6 and/or the plates 8 and 9 and possibly also the fusible link 17 which connects the plates are heated so that triggering and release of the triggering mechanism also occurs virtually immediately because the fusible link can be caused to melt very quickly with the flow of current.

So that the known fusible link sprinkler therefore has an “electrically triggerable function” it only requires a line connection and a closed circuit, for example at the receiving means 12 and the sprinkler frame 14, 17.

When the switch S is closed a current I flows from the voltage source or current source (the voltage source can be a dc voltage but also an ac voltage source); by virtue of integration of the extinguishing fluid-conducting element in the illustrated circuit the current also flows through the levers 5 and 6, or the plates 8 and 9, and the interposed fusible link 23. The fusible link material is preferably a material which has a specific electric resistance.

A typical material for the fusible link is beryllium nickel UNS-N03360. Such a beryllium nickel alloy has a specific electrical resistance of 28.7 to 43 μcm. Another fusible link material with an even greater specific electrical resistance is also suitable according to the invention and then leads to even faster melting so that even quicker triggering is possible.

If moreover the rod 5 and the lever 6 are also heated by the flow of current therethrough, then as mentioned, that results in very rapid attainment of the melting temperature of the fusible link and then virtually electric triggering of the indicated fusible link sprinkler.

FIG. 2 does not show that the switch S can also be controlled, that is to say closed, by a sensor, for example a room, radiation or temperature sensor when a value detected by the sensor exceeds a predetermined value.

FIG. 3 also shows the application of the invention for a control valve having an input line 20 and two output lines 21, 22. Those lines are designed for the flow of fluid extinguishing agent. As can be seen from FIG. 2 the triggering mechanism 4 is again provided between two pressure points.

In FIG. 3 the fusible link opening element—this is indicated by the circle—is of a configuration as shown in FIG. 2.

While the two pressure points in FIG. 1 form the screw 3 and the support 11 of the receiving means 12 the pressure points in FIG. 2 in turn comprise a screw 30 and a valve stem 31. The valve stem 31 in that case presses (from below) against a plate 32 which in turn bears against a counterpart mounting 34 of the control valve and on the other hand carries the triggering mechanism 4.

In the interior of the control valve the valve stem 31 with its rear part (not visible) closes the through-flow of a fluid extinguishing agent which bears with its pressure against the lower connection of the control valve.

When the triggering mechanism is triggered by closure of an electric switch S, as with the same or similar functionality as described with reference to FIG. 2, the valve stem is moved upwardly by the fluid pressure and thus enables the through-flow of the fluid extinguishing agent through the two outlets 21 and 22.

As an alternative to the illustrated structure in FIG. 2 or FIG. 3 it is also possible for a heating wire resistance to be connected to the fusible link or arranged close thereto, and when then the heating wire resistance has a current flowing therethrough, the resistance is heated and thus causes the fusible link to melt.

A further preferred embodiment is moreover one in which the fusible link or the two plates 8, 9 which are connected by means of the fusible link are made from a material which has very good heating wire resistance properties, therefore a high specific resistance, so that when current flows through those parts, heat which is as great as possible is generated, very rapidly causing the fusible link to melt.

The thermal heating element (heating wire resistance) can be in the form of a heating resistance or in the manner of a safety fuse (such safety fuses are state of the art), that is to say, when the current flows through the safety fuse, not only is sufficient heat generated to melt the fusible link, but in that case the safety fuse itself is also destroyed (ruptured).

In that respect the safety fuse is so designed that it can have a predetermined current strength flowing therethrough for a predetermined period of time, and it is so designed that on the one hand sufficient heat is generated to reliably melt the fusible link, but on the other hand also for melting the safety fuse.

A further variant provides that the fusible link itself is electrically conductive and/or magnetic and is surrounded by a coil which, when a current flows through the coil, applies a force to the fusible link which causes it to rupture or which again heats the fusible link to such a degree that it virtually instantly melts and thus enables the sprinkler or valve function.

FIG. 4 shows a sketch of a surface which is subdivided into four sectors a, b, c, d. In that arrangement a corresponding switch S1, S2, S3, S4 is associated with each sector so that if necessary the corresponding sprinklers of a sector can be activated by closure of the corresponding switch, that is to say with a single switch command, for example with closure of the switch S1, the sprinklers of the sector a can virtually simultaneously begin to apply water to the surface of the sector a.

It is naturally also possible to cause all sprinklers of all sectors to be activated with a single switch which in FIG. 3 is arranged as the switch S5.

The switches can be fitted in the fire alarm and/or extinguishing control center (BMZ), but can also be associated spatially with the individual sectors in order if necessary, when a fire is developing, to be triggered by the corresponding personnel. The individual association of switches with the sprinklers however is also conceivable.

Insofar as FIG. 2 shows the solution according to the invention for a dc voltage/direct current source, it is noted that the invention also functions equally well with an ac voltage/alternating current source.

The voltage/current-carrying cables to the sprinkler can be fitted at the sprinkler or its feed components (like for example sprinkler pipes) both releasably (for example by screw means) or also non-releasably (for example welding, soldering, gluing), while a clamping mounting is also possible. If it important that an electrically conducting contact is ensured at any time between the current/voltage-carrying cables and the connected components of the sprinkler so that, with closure of the switch, the above-mentioned current can flow in order to melt the fusible link and thus trigger the sprinkler.

Division of an area into various sectors, for example in a large hall, in a large building, and so forth, is known as such, for example from US 2017/0120090, FIG. 1. It will be noted however that it is not known from that document for individual sectors also to have associated corresponding switches, by means of which electrical triggering of the provided sprinklers can be enabled.

The invention also includes the possibility that in a test mode electrical conductivity is tested, by a low testing current flowing through the line (for a short time) and by the existence of the electrical contacts and the conductivity of the current through the defined current path being tested by measurement of the test current. The current which occurs in that case can be measured but is not sufficient to cause the fusible link to melt.

Such a testing operation can also be routinely carried out at recurring intervals, for example once a week, once a year and so forth, and in that respect the test result can be recorded, stored and/or represented at a suitable display in the fire alarm and/or extinguishing control center (BMZ).

As mentioned, a test cycle is designed such that the current-carrying parts have a current flow therethrough, which is markedly lower than the current, by means of which the fusible link sprinkler can be electrically triggered.

If for example the current for electrically triggering the fusible link sprinkler is 10 A, then a markedly lower test current is a current of the order of magnitude of 10%, that is to say 1 A or less, for example 1 mA. It is crucial that in the test cycle the test current can still be reliably measured.

The test cycle according to the invention has the advantage that it is possible therewith under some circumstances to detect damage to the sprinkler. Ageing of the components of the sprinkler can also be detected therewith, more specifically when the components of the sprinkler, through which the current flows, are of an increased or reduced resistance by virtue of their ageing, which can occur due to material shrinkage, material oxidation and other ageing influences and also environmental influences.

It is possible to establish by means of the test cycle whether a sprinkler was exposed to an excessively high temperature upon transport to the installation position. If that was the case, it is possible to encounter invisible separation of the two plates, whereby the electrical conduction properties are decreased, which can be detected in the test cycle.

FIG. 5 shows a cross-section through an alternative arrangement or configuration of a fusible link sprinkler. The references respectively relate to the parts which are also described with reference to FIG. 2.

It is to be noted that the mechanical structure and thus the mechanical layout of the sprinkler shown in FIGS. 5 and 6 is known as such, for example from U.S. Pat. No. 4,623,023. FIG. 5 however shows how such a sprinkler can be equipped so that it is also electrically triggerable.

The sole essential difference lies in the configuration and arrangement of the rod 5, the lever 6 and the plates 8 and 9. As can be seen from FIG. 5 the plate 9 is an integral component part of the rod 5, in contrast the plate 8 is an integral component part of the lever 6. As can be seen from FIG. 5 the rod 5 is arranged inclined slightly out of the center line Z so that the screw acts on the front part of the lever 6 so that when the screw is tightened the lever with the plate 8 thereof tries to move away from the rod or its plate 9. That is prevented by the fusible link 23 between the plates 8 and 9 as long as it is still in a solid state and as long as that fusible link is still not heated so greatly to its predefined triggering temperature. If that happens by virtue of closure of the switch S a current I then flows through the electrical circuit in which the fusible link opening element is integrated.

FIG. 6 shows a perspective view of the fusible link sprinkler of FIG. 5.

It can be clearly seen from the Figure that the external structure of the fusible link sprinkler is similar to the structure known from FIG. 1b, and that the essential difference only involves the structure, configuration and arrangement of the levers 5 and 6 as well as the plates 8 and 9 which are connected together by the fusible link.

It is further noted that electrical testing to ascertain whether a fusible link sprinkler is operational is known as such, for example from US 2017/0120090. The solution shown in that state of the art however is extremely complicated and only allows technical functional testing but not electrical triggering of a fusible link sprinkler.

As shown in the present application however with the devices for electrical triggering of the fusible link sprinkler when the electrically conducting parts are only acted upon with a low test current, it is also possible to perform technical functional checking, as mentioned, but without causing triggering of the sprinkler.

Accordingly the configuration and structure according to the invention of the extinguishing fluid-conducting element also permits implementation of a method of testing the extinguishing fluid-conducting element, in which respect there is then a test cycle in which a test current flows through the electrical circuit, wherein the test current is markedly lower, that is to say for example less than 10%, 5% or less than the current for triggering the fusible link opening element, and wherein in the test cycle the contacts and/or ageing or functional capability of the extinguishing fluid-conducting element or the fusible link opening element are checked, if for example it is established in the test cycle that the test current does not flow through the electrical circuit, it is to be assumed that there is a cycle interruption, for example a line break, so that in such a case it is possible to perform targeted fault checking or maintenance.

Thus it is possible to entirely dispense with the highly complex test structure as is known from US 2017/0120090 and a simpler structure is provided, which has at the same time at least two functions, more specifically on the one hand the possibility of effecting functional testing of the sprinkler and on the other hand also implementing electrical triggering thereof.

### LIST OF REFERENCES

1 fusible link sprinkler
2 deflector
3 screw
4 triggering mechanism
5 rod
6 lever
7 front part
8 first plate
9 second plate
10 foot end
11 support
12 receiving means
13 shoulder
14 sprinkler body
15 thread
16 spring
17 frame
18 first line
19 second line
21 first output line
22 second output line
23 fusible link
24 outward direction
25 head end
26 recess
27 voltage/current source
30 screw
31 valve stem
32 plate
34 counterpart mounting
S switch

1. An extinguishing fluid-conducting element for a firefighting installation having a blocking and an enabled state, wherein the extinguishing fluid-conducting element has a fusible link opening element having a predetermined electrical resistance, wherein the fusible link opening element is integrated in an electrical circuit which has a switch (S) and through which when the switch (S) is closed there flows a current by which the fusible link opening element is opened.

2. The extinguishing fluid-conducting element as set forth in claim 1 wherein the fusible link opening element has a fusible link and the fusible link softens, melts, or disintegrates by the flow of the electric current through the fusible link opening element.

3. The extinguishing fluid-conducting element as set forth in claim 2 wherein the extinguishing fluid-conducting element has a thermal resistance which touches the fusible link opening element or is arranged in the immediate proximity thereof and which is integrated in the electrical circuit and which when the switch (S) is closed generates a predetermined amount of thermal energy, by which the fusible link is heated so that the parts of the fusible link opening element which are held together by the fusible link are released from each other.

4. The extinguishing fluid-conducting element as set forth in claim 1 wherein the extinguishing fluid-conducting element is a fusible link sprinkler or a control valve having a fusible link opening element.

5. A fire extinguishing installation having a blocking and an enabled state, comprising an extinguishing fluid-conducting element as set forth in claim 1.

6. A method of testing an extinguishing fluid-conducting element as set forth in claim 1 wherein there is provided a test cycle in which a test current flows through the electrical circuit, wherein the test current is markedly lower than the current for triggering the fusible link opening element and wherein in the test cycle contacts and/or ageing or functional capability of the extinguishing fluid-conducting element or the fusible link opening element are checked.
